(19) United States
(12) Patent Application Publication
(10) Pub. No.: US 2009/0044645 A1
(43) Pub. Date: Feb. 19, 2009

(54) Motor driven linear actuator

(76) Inventor: Hans-Joachim Buescher, Duesseldorf (DE)

Correspondence Address: DELPHI TECHNOLOGIES, INC., M/C 480-410-202, PO BOX 5052, TROY, MI, 48007, US

(21) Appl. No.: 12/220,115

(22) Filed: Jul. 22, 2008

(30) Foreign Application Priority Data
Aug. 14, 2007 (GB) 0715754.8
Sep. 20, 2007 (EP) 07018504.6

(51) Int. Cl. F15B 15/06

(52) U.S. Cl. 74/89

(57) ABSTRACT

The present invention relates to a linear actuator in whose housing an electric motor is fastened for the driving of a threaded spindle which receives a spindle nut which converts the rotary movement of the threaded spindle into a translatory movement and with which the actuation rod extending out of the housing is coupled. The threaded spindle has an internal thread circumscribing a hollow space of the threaded spindle, whereas the spindle nut has an external thread in engagement with the internal thread of the threaded spindle so that the actuation bar can be moved in or out of the hollow space of the threaded spindle in the manner of a telescope depending on the direction of rotation of the threaded spindle.

### TECHNICAL FIELD

The present invention relates to a linear actuator which is driven by an electric motor and which converts the rotary movement of the electric motor into a translatory or linear movement of a spindle drive.

### BACKGROUND OF THE INVENTION

Linear actuators of this type can be used, for example, in the field of automotive engineering where they are used, for example, for the opening and closing of tailgates, trunk lids, engine hoods or the like.

So that the whole weight of a tailgate does not have to be moved or intercepted on the opening or closing of a tailgate, for example, weight compensation systems or counterweight systems are usually used which compensate the weight of the tailgate so that only a small additional force is required for the opening of the tailgate, said force being able to be applied either by hand or by means of an actuation actuator. With tailgates actuable by hand, for example, two gas pressurized springs are usually used as the counterweight system which compensate the weight of the tailgate.

To provide the desired weight compensation for a tailgate, for example, which is actuated by a motor driven linear actuator, a weight compensation system can be used which is either integrated into the linear actuator or is provided as a separate unit. Separate weight compensation systems are frequently usual gas pressurized springs which provide the desired weight compensation. Integrated weight compensation systems are, in contrast, mostly a question of a helical compression spring which is integrated into the linear actuator and provides the desired weight compensation.

However, due to the integration of such a helical compression spring into the linear actuator, its diameter increases, on the one hand, since the helical compression spring is arranged concentrically to the parts of the linear actuator moving in a translatory manner or to its spindle drive. On the other hand, due to the integration of such a helical compression spring into the linear actuator, its length also increases since the block length of the helical compression spring is not available as a stroke path.

Since a gas pressurized spring is integrated into a linear actuator, it is admittedly possible to minimize its length; however, such linear actuators nevertheless have a comparatively large diameter.

### SUMMARY OF THE INVENTION

It is therefore the underlying object of the invention to provide a linear actuator which can be actuated by an electric motor and is as compact and as small in construction size as possible.

This object is satisfied by a linear actuator having the features of claim 1.

The linear actuator in accordance with the invention has an electric motor which is fastened inside the housing of the linear actuator and drives a threaded spindle likewise arranged in the housing. The threaded spindle takes up a spindle nut which converts the rotary movement of the threaded spindle into a translatory linear movement, for example to open or close a tailgate. In order in this process to be able to transfer the translatory movement of the spindle nut to a tailgate, an actuation bar extending out of the housing is coupled to the spindle nut. In this connection, for example, fastening eyelets can be provided at the free end of the actuation bar as well as at the oppositely disposed end of the housing and the linear actuator can be pivotally connected to the body and to the tailgate via said fastening eyelets.

Provision is now made in accordance with the invention for the threaded spindle to have an internal thread circumscribing a hollow space of the threaded spindle, whereas the spindle nut has an external thread in engagement with the internal thread of the threaded spindle so that the actuation bar is moved in and out of the hollow space of the threaded spindle in the manner of a telescope in dependence on the direction of rotation of the threaded spindle when the threaded spindle is rotatably driven by the electric motor.

Unlike conventional threaded spindles, the threaded spindle of the linear actuator in accordance with the invention therefore does not have an external thread, but an internal thread. In a corresponding manner, unlike spindle nuts associated with conventional threaded spindles, the associated spindle nut does not have an internal thread, but an external thread so that the spindle nut is caused to make a linear movement in the hollow space of the threaded spindle on a rotation of the threaded spindle.

It would likewise admittedly be possible to consider the component called a threaded spindle within the framework of the present invention as a long spindle nut due to its internal thread and accordingly to consider the component called a spindle nut within the framework of the present invention as a (short) threaded spindle due to its external thread; since, however, the component with an internal thread called a threaded spindle within the framework of the present invention is subjected to a rotary movement by the electric motor, whereas the component called a spindle nut within the framework of the invention is subjected to a translatory linear movement over the length of the threaded spindle by the rotary movement of the threaded spindle, the terminology for the components in question is oriented on the fact, in agreement with conventional spindle drives, that the rotary component is the threaded spindle, whereas the component moving in a translatory manner as a result of the rotation of the threaded spindle is the spindle nut. The threaded spindle is thus, in agreement with the conventionally used terminology, the longer component with a higher number of turns, whereas the spindle nut is the shorter component with a lower number of turns.

For the actuation of the linear actuator, the threaded spindle is set into rotation inside the housing with the help of the electrical motor and, optionally, a transmission unit interposed between the electric motor and the threaded spindle, which has the result as a consequence of the threaded engagement of the spindle nut with the threaded spindle that the spindle nut is caused to make a translatory linear movement together with the actuation bar coupled thereto, in which movement the actuation bar is moved in or out in the manner of a telescope depending on the direction of rotation of the threaded spindle in the hollow space of said actuation bar.

Preferred embodiments of the linear actuator in accordance with the invention will be looked at in the following which also result from the dependent claims, from the description of the Figures and from the drawings.

Since the actuation bar can be the pressurized gas cylinder of a pressurized gas spring, which will be looked at in more detail later, a very compact construction can be achieved by the design of the threaded spindle in accordance with the invention, since not only the actuation bar can be arranged within the threaded spindle, but also suitable means with which the actuation bar can be subjected to a biasing force which has the tendency to press it out of the hollow space of the threaded spindle. It would thus be possible, for example, to arrange a helical compression spring within the hollow space of the threaded spindle which is supported at an end surface of the threaded spindle, on the one hand, and at the threaded nut, on the other hand, in order thus to be able to apply the desired biasing force for the weight compensation onto the actuation bar via the spindle nut.

Since, however, the total length of the linear actuator in accordance with the invention would increase in an unwanted manner due to the block length of such a helical compression spring, provision is made in accordance with a preferred embodiment to design the actuation bar in the already previously described manner as a pressurized gas cylinder whose piston rod extends at a fixed position within the hollow space of the threaded spindle. Since no spiral compression spring is arranged within the threaded spindle in this preferred embodiment, the total length of the threaded spindle is available for the desired linear movement of the spindle nut or of the actuation bar coupled thereto, whereby the total length of the linear reactor can be reduced.

Since a pressurized gas spring is designed as a rule only for approximately 30,000 actuation cycles, but a tailgate should withstand approximately 50,000 actuation cycles without damage, there is a need to design the linear actuator in accordance with the invention such that its pressurized gas spring comprising a pressurized gas cylinder and a piston rod is easily accessible and can preferably be replaced.

Accordingly, the actuation bar in accordance with an embodiment can have a hollow cylindrical design, with the actuation bar receiving the pressurized gas cylinder of a pressurized gas spring in its hollow space, the piston rod of said pressurized gas spring extending within the hollow space of the threaded spindle, as has already bee described above. The actuation bar of the linear actuator thus so-to-say serves as a housing for the reception of the pressurized gas spring or its pressurized gas cylinder so that the pressurized gas spring can be replaced easily as required.

To further simplify such a replacement, the hollow space of the actuation rod is preferably bounded at the end of the actuation rod locate outside the housing of the linear actuator by a closing body attached releasably to the actuation bar, preferably via a threaded connection. To be able to replace the pressurized gas spring, only the named closing body, which can, for example, be a kind of closing cap, thus has to be removed or unscrewed from the actuation bar so that the hollow space of the actuation bar is freely accessible from the outside and the pressurized gas spring to be replaced can be pulled out of the hollow space of the actuation bar and a new pressurized gas spring can be inserted.

As already previously stated, the hollow cylindrical design of the threaded spindle or its hollow space can be bounded at one end by an end surface at which the piston rod of the pressurized gas spring is supported. For this purpose, for the reception of the piston rod, a blind hole recess can be formed in the end surface so that the piston rod cannot escape to the side. At the side of the end surface disposed opposite the piston rod, said end surface can furthermore have a suitable engagement opening, for example likewise in the form of a blind hole recess, into which the drive shaft of the electric motor, or in the event of a transmission unit interposed between the electric motor and the threaded spindle, its output shaft, can engage in a shape-matched manner for the purpose of driving the threaded spindle.

To avoid unwanted friction phenomena as a result of the rotation of the threaded spindle within the housing, the threaded spindle can furthermore be rotatably supported in the housing via at least one roller bearing, whereby it is simultaneously ensured that the threaded spindle does not jam in the housing.

It would admittedly generally be possible to equip the actuation bar over its total length with an external thread which is in more or less deep engagement with the internal thread of the threaded spindle depending on the actuation position of the linear actuator so that a defined and delineated spindle nut at the end of the actuation bar located within the housing can be dispensed with. However, the dirt seal of the housing of the linear actuator with respect to the actuation bar proves to be problematic in the event of an external thread extending over its total length so that provision is made in accordance with a preferred embodiment for the actuation bar to have a smooth shaft on the peripheral side at whose end within the interior of the housing the spindle nut is formed. The spindle nut and the actuation rod can be connected to one another in one piece in that the actuation bar with the spindle nut shaped thereon is worked out of a single workpiece.

Since this working of the spindle nut and of the shaft of the actuation bar from a single workpiece, for example by milling, is very labor intensive and time consuming, the spindle nut can be releasably connected to the actuation bar, preferably via a threaded connection, in accordance with a further embodiment. The spindle nut and the shaft of the actuation bar can thus be made separately and can be connected to one another, for example, by a suitable connection technique such as by screwing.

To further reduce the friction during the operation of the linear actuator in accordance with the invention, the spindle nut can be made as a as a ball screw in conjunction with the threaded spindle. Since the spindle nut and the threaded spindle thus only contact one another via plurality of balls, the friction between the spindle nut and the threaded spindle is reduced, whereby less force has to be applied by the electric motor for the actuation of the linear actuator.

In accordance with a preferred embodiment, the spindle nut can be made as a free wheeling ball screw in conjunction with the threaded spindle. Such a free wheeling ball screw is characterized in that the balls are received in ring-shaped grooves in the spindle nut and are received by a cage between the spindle nut and the threaded spindle. When the cage of the spindle nut reaches a boundary at the end of the threaded spindle, the linear movement of the spindle nut stops since the grooves running in ring form in the spindle nut then ensure that no further advance movement occurs. Although the threaded spindle continues to rotate, no further pressure is thus exerted onto the boundary of the threaded spindle. This embodiment proves to be advantageous in that no further linear movement is caused in the event of a failure of the control of the electric motor due to the design of the spindle nut and the threaded spindle as a free wheeling ball screw despite the continuing drive of the linear actuator by the spindle nut, whereby the risk of overheating of the electric motor can be reduced.

### BRIEF DESCRIPTION OF THE DRAWINGS

The invention will now be described purely by way of example in the following with reference to different exemplary embodiments and to the enclosed drawings in which:

FIG. 1 shows a schematic representation of a first embodiment of a linear actuator in accordance with the invention;

FIG. 2 shows a schematic representation of a second embodiment of a linear actuator in accordance with the invention in the region of the actuation bar; and

FIG. 3 shows a schematic representation of a third embodiment of a linear actuator in accordance with the invention in the region of the actuation bar.

### DESCRIPTION OF THE PREFERRED EMBODIMENT

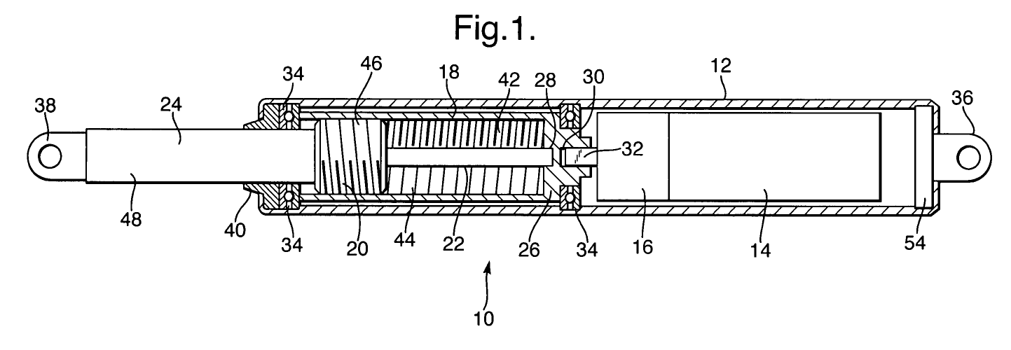

FIG. 1 shows a first embodiment of a linear actuator 10 in which the actuation rod 24 is simultaneously the pressurized gas cylinder 48 of a pressurized gas spring 24, 22. The linear actuator 10 shown in FIG. 1 has a substantially hollow cylindrical housing 12 in which an electric motor 14 coupled to a transmission 16 is fixedly arranged. Furthermore, a threaded spindle 18 is arranged in the housing 12 and is supported via two mutually spaced apart roller bearings 34 in the interior of the housing 12 at its inner wall. The threaded spindle 18 is a substantially hollow cylindrical component which is arranged concentrically to the housing 12 of the linear actuator 10. The threaded spindle 18 thus forms a hollow space 42, with an internal thread 44 being formed at the inner wall of the threaded spindle 18 surrounding the hollow space 42.

The hollow space 42 of the threaded spindle 18 is bounded by an end surface 26 in the form of a wall at the side facing the transmission 16. This wall 26 has, at the side facing the transmission 16, an engagement recess in the form of a blond bole recess 30 into which the output shaft 32 of the transmission 16 engages in a shape-matched manner to be able to drive the threaded spindle 18 rotatably.

Furthermore, the linear actuator 10 has a spindle nut 20 which is located in the hollow space 42 of the threaded spindle 18. The spindle nut 20 is provided at its outer periphery with an external thread 46 which is in engagement with the internal thread 44 of the threaded spindle 18 so that the spindle nut 20 is screwed to the front or to the rear in the longitudinal direction of the threaded spindle 18 depending on the direction of rotation of the threaded spindle 18.

An actuation bar 24 is coupled to the spindle nut 20 and extends out of the housing 12 through an outlet opening of the housing provided with a sealing element 40.

The rotary movement caused by the electric motor 14 is transmitted via the transmission 16 and particular via its output shaft 32 to the threaded spindle 18 which converts the rotary movement into a translatory linear movement of the spindle nut 20 in conjunction with the spindle nut 20 located in the hollow space 42 thereof so that the actuation bar 24 is moved in or out of the hollow space 42 of the threaded spindle 18 in the manner of a telescope depending on the direction of rotation of the threaded spindle 18.

On this actuation of the linear actuator 10, only the threaded spindle 18 is caused to carry out a rotary movement, whereas the spindle nut 20 does not carry out any rotary movement. The spindle nut 20 is rather only moved forward or backward in the longitudinal direction of the threaded spindle 18 as a result of the threaded engagement with the internal thread 44 of the threaded spindle 18 to be able to move the actuation bar 24 into and out of the housing 12 or the hollow space 42 of the threaded spindle 18 in the manner of a telescope.

To be able to use the linear movement of the linear actuator 10 for the opening and/or closing of a tailgate of a motor vehicle, for example, the linear actuator 10 in accordance with the invention has in each case a fastening eyelet 36, 38 at its two oppositely disposed ends, with the one fastening outlet 38 being formed at the freely projecting end of the actuation bar 24, whereas the other fastening outlet 36 is formed at a closing cover 54 which is releasably attached to the housing 12 and which can be removed from the housing 12 for inspection or repair purposes.

So that the force required, for example, for the opening of a tailgate does not necessarily have to be applied only by the electric motor 14, the actuation bar 24 can be under a biasing force which has the tendency to press the actuation bar 24 out of the hollow space 42 of the threaded spindle 18. Such a biasing force could, for example, be generated onto the actuation bar 24 or the spindle nut 20 coupled thereto via a helical compression spring which is located in the hollow space 42 and which is supported at the spindle nut 20, on the one hand, and at the end surface 26, on the other hand.

Since, however, in this case, due to the block length of a helical compression spring arranged in this manner, the total length of the threaded spindle 18 would not be available as a stroke distance for the spindle nut 20 and the actuation bar 24, provision is made in accordance with a preferred embodiment for the named biasing force to be applied with the help of a pressurized gas spring. Accordingly, the actuation bar 24 in this preferred embodiment is made as a pressurized gas cylinder 48 of a pressurized gas spring whose piston rod 22 extends in a fixed position and concentrically within the hollow space 42 of the threaded spindle 18, as is the case in the embodiment shown in FIG. 1. At the end of the piston rod 22 disposed opposite the spindle nut 20, the piston rod 22 engages into a blind hole recess 28 formed in the end surface 26. The piston rod 22 in conjunction with the actuation bar 24 formed as a pressurized gas cylinder 48 thus forms a pressurized gas spring which has the tendency due to the different sizes of the pressure-active surfaces at both sides of the piston (not shown here) within the pressurized gas cylinder 24 to press the pressurize gas cylinder 24 out of the hollow space 42 of the threaded spindle 28.

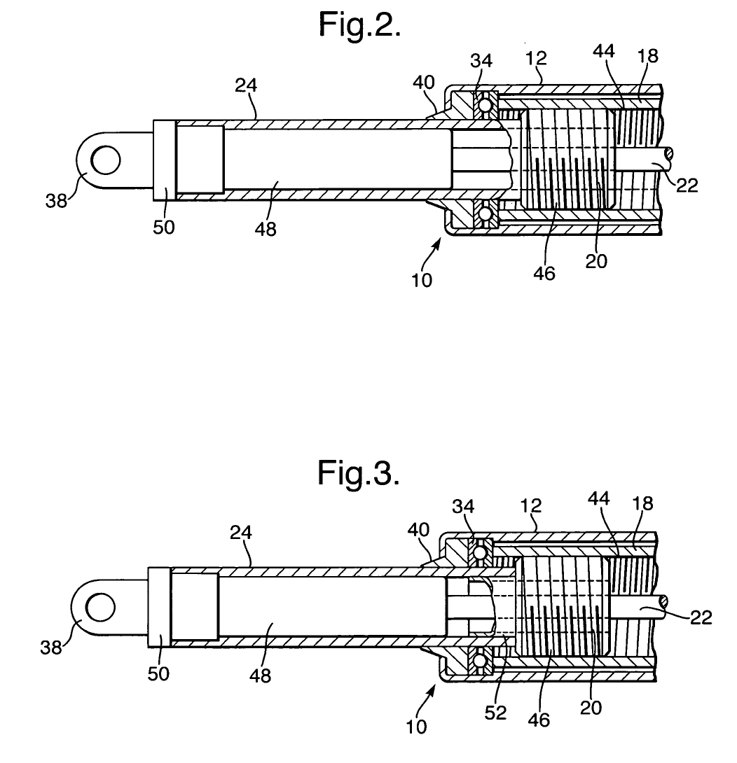

To be able to replace the pressurized gas spring comprising a pressurized gas cylinder 48 and a piston rod 22 as fast and as simply as possible, provision is made in accordance with another embodiment, which is shown in FIG. 2, to form the pressurized gas cylinder 48 as a component separate from the actuation bar 24. As can be seen from FIG. 2, the actuation bar 24 also has a hollow cylindrical design in this embodiment, with the actuation rod 24 in this embodiment, however, receiving in its hollow space the pressurized gas cylinder 48 of a pressurized gas spring whose piston rod 22 extends at a fixed position and concentrically within the hollow space 42 of the threaded spindle. In this connection, the pressurized gas cylinder 48 is easily accessible from the outside via a closing body 50 releasably attached to the free end of the actuation bar 24 so that the pressurized gas spring 48, 22 can easily be pulled out of the hollow space of the actuation bar 24 after the closing body 50 has been removed from the actuation bar 24.

In the two embodiments shown in FIGS. 1 and 2, the spindle nut 20 is connected to the actuation bar 24 in one piece. It can, however, prove to be advantageous from a technical production aspect to produce the spindle nut 22 as a separate component and only to connect it to the actuation bar 24 subsequently. For example, the spindle nut 20 can thus be releasably connected to the actuation bar 24 via a threaded connection 52 in accordance with FIG. 3 so that the actuation bar 24 made as a pressurized gas cylinder 48 (in accordance with FIG. 1) can also be replaced easily in the event that, deviating from FIG. 2, the pressurized gas spring or its pressurized gas cylinder 48 should not be designed as a component separate from the actuation bar 24.

Having thus described the invention, it is claimed:

1. A linear actuator comprising:
a housing;
an electric motor fixed in the housing;
a threaded spindle arranged in the housing and rotatably driven by the electric motor;
a spindle nut which is received by the threaded spindle and converts the rotary movement of the threaded spindle into a translatory movement; and
an actuation bar which extends out of the housing and is coupled to the spindle nut,
wherein the threaded spindle has an internal thread which circumscribes a hollow space of the threaded spindle; and in that the spindle nut has an external thread in engagement with the internal thread of the threaded spindle so that the actuation bar can be moved in and out of the hollow space of the threaded spindle in the manner of a telescope depending on the direction of rotation of the threaded spindle.

2. The linear actuator of claim 1, wherein the actuation bar is under a biasing force which has the tendency to press it out of the hollow space of the threaded spindle.

3. The linear actuator of claim 1, wherein the actuation bar is the cylinder of a pressurized gas spring whose piston rod extends in a fixed position within the hollow space of the threaded spindle.

4. The linear actuator of claim 1, wherein the actuation bar has a hollow cylindrical design, with the actuation bar receiving in its hollow space the cylinder of a pressurized gas spring whose piston rod extends at a fixed position within the hollow space of the threaded spindle.

5. The linear actuator of claim 4, wherein the hollow space of the actuation bar is bounded at the end of the actuation bar located outside of the housing by a closing body releasably attached to the actuation bar.

6. The linear actuator of claim 1, wherein the threaded spindle has a hollow cylindrical design whose hollow space is bounded at one end by a wall at which the piston rod is supported.

7. The linear actuator of claim 1, wherein the threaded spindle is rotatably supported in the housing.

8. The linear actuator of claim 1, wherein the spindle nut is releasably connected to the actuation bar.

9. The linear actuator of claim 1, wherein the spindle nut is made in one piece with the actuation rod.

10. The linear actuator of claim 1, wherein the spindle nut is made in conjunction with the threaded spindle as a ball screw and in particular as a free wheeling ball screw.
